(19) United States
(12) Patent Application Publication
(10) Pub. No.: US 2005/0008135 A1
(43) Pub. Date: Jan. 13, 2005

(54) Selective incoming call filtering and blinded caller ID display

(76) Inventor: Joshua R. Bressler, New York, NY (US)

Correspondence Address: Patrick J. Fay, Esq.;FAY KAPLUN & MARCIN, LLP, Suite 702, 150 Broadway, New York, NY, 10038, US

(21) Appl. No.: 10/615,657

(22) Filed: Jul. 9, 2003

(51) Int. Cl. H04M 3/42; H04M 1/56; H04M 15/06

(52) U.S. Cl. 379/211.01; 379/142.01

(57) ABSTRACT

A software package comprises a source identifying module for determining source data corresponding to a source of incoming telephone calls and a call handling module including instructions for each of a plurality of call handling modes in combination with a handling mode selection module determining which call handling mode controls handling of incoming calls based on the source data and a time of receipt of the incoming calls. A method of controlling operation of a telephone comprises the steps of extracting source data from an incoming call, the source data corresponding to a source of the call and the step of specifying a set of call handling instructions for each of a plurality of call handling modes in combination with the step of selecting one of the call handling modes for each incoming call received based on the source data and a time of receipt of the incoming call.

### BACKGROUND INFORMATION

Technological advances have significantly changed telecommunications. Particularly, telephone capabilities have changed dramatically over the last few years. Many features currently available on cellular phones such as phone books, calendars, text messaging, games, calculators, and even wireless Internet services were not widely available previously. A feature that has become readily available in both standard and cellular phones is caller identification (caller ID). Caller ID is a function of the telephone that allows a call recipient of the telephone to view information regarding the incoming call. Typically, a display associated with a call recipient's telephone, either integrated into the telephone itself or as a part of specifically tailored hardware (e.g., as an external display box) may display a telephone number and/or a name associated with an incoming call.

Depending on the characteristics of the individual system, caller ID may provide one or more of the following services. First, caller ID data may be provided for incoming calls received when a call recipient is not currently using the phone (i.e., the phone is “on the hook”). When the phone rings, the call recipient may look at the display to decide, based on the displayed information, whether to answer the incoming call.

When operated in conjunction with a call waiting feature, a call recipient already engaged in a telephone call (i.e., the phone is “off the hook”) may be alerted to an additional, incoming call by a call waiting tone. The call recipient may then view the caller ID display to determine whether to switch over to the incoming call and temporarily place the first call on hold.

Finally, some caller ID systems have interacted with data in an internal electronic phone book to assign a different ring to each of a selected number of phone book entries or groups of entries. Under this system, when a call is received from a telephone number corresponding to one of the selected phone book entries, its assigned ring allows the call recipient to identify the caller or the group to which the caller belongs.

### SUMMARY OF THE INVENTION

The present invention is directed to a software package comprising a source identifying module for determining source data corresponding to a source of incoming telephone calls and a call handling module including instructions for each of a plurality of call handling modes in combination with a handling mode selection module determining which call handling mode controls handling of incoming calls based on the source data and the time of receipt of the incoming calls.

The present invention is further directed to a method of controlling operation of a telephone which comprises the steps of extracting source data from an incoming call, the source data corresponding to a source of the call and the step of specifying a set of call handling instructions for each of a plurality of call handling modes in combination with the step of selecting one of the call handling modes for each incoming call received based on the source data and the time of receipt of the incoming call.

### BRIEF DESCRIPTION OF DRAWINGS

FIG. 1 shows an exemplary embodiment of a standard telephone system.

FIG. 2 shows an exemplary embodiment of a set of groups.

FIG. 3 shows an exemplary data input process.

FIG. 4 shows an exemplary time schedule for rings.

FIG. 5 shows an exemplary process by which a determination is made as to which ring to initiate in response to a received incoming call.

### DETAILED DESCRIPTION

The present invention may be further understood with reference to the following description of preferred exemplary embodiments and the related appended drawings, wherein like elements are provided with the same reference numerals. The present invention enhances a call recipient's ability to use caller ID data to control the handling of incoming calls.

Although the following description will be discussed in reference to cellular phones, those skilled in the art will recognize that the present invention may be implemented on any device that serves as a means of communication, for example, any device that operates with a phone line such as a computer or answering machine, or any device that has wireless telecommunication capabilities such as a wireless two-way pager or a personal digital assistant.

Although caller ID allows telephone call recipients to filter incoming calls, the called party's privacy may still be intruded upon by unwanted rings, for example, during evening hours, when asleep, when working, when children are asleep, or when entertaining guests. To avoid such disturbances, the call recipient may disconnect the phone, take it “off the hook,” or turn off the ringer. However, these alternatives may be undesirable since they impede all calls including those that a call recipient still may wish to answer personally when received, such as emergency calls. The present invention allows a call recipient to specify ring types based on the origin of the incoming calls and time of receipt to tailor telephone operation to the call recipient's desired schedule.

According to a first illustrative embodiment of the invention, the caller ID function is integrated into the call recipient notification process (e.g., by controlling call processing options). Specifically, the call recipient is provided with the option to specify different notification characteristics for the phone numbers in an internal memory as described below, as well as specifying notification characteristics for incoming call numbers not found in the internal memory, in combination with a clock and/or calendar to adapt the operation of the phone to different time and/or date circumstances.

The software allows for many different typifications in the handling of incoming calls. Firstly, the call recipient will be able to specify a different type of ring for each type of call, including a silent ring (e.g., vibrating phone or lighting display screen or no action whatsoever). The silent ring mode allows a call recipient to be notified of incoming calls without a ring notifying or disturbing other people present. Alternatively, a call recipient may direct the phone to forward selected incoming calls directly to a voice mail system or to another phone based on caller ID data without notification of the incoming call. For example, if this option was selected for a home phone and the call recipient wanted to forward all calls from a certain group of people, such as family members, to a cellular phone number while not in the house, the call recipient may indicate which numbers should be forwarded in this manner as described in more detail below.

The system according to the present invention furthers this collaborative call handling process by allowing caller ID to act as a trigger. For instance, if the call recipient is already engaged in a phone conversation and does not want to be interrupted except by incoming calls originating from any of a restricted group of numbers, the call recipient may set the phone to sound the call waiting tone only when an incoming call is received from one of the permitted numbers. Furthermore, the call recipient may choose to send a second class of calls originating from a second group of numbers directly to the voice mail system rather than sounding a tone and interrupting the ongoing conversation. Similarly, the call recipient may set a different call waiting tone for each of a plurality of numbers or groups of numbers to provide the call recipient with information on which to base a decision regarding interrupting the current call.

The present invention allows call recipients to organize phone numbers together into “groups”, with each group representing a call handling priority or function to be applied to incoming calls originating therefrom. A group may contain any number of different entries and may be inclusive or exclusive. For example, a call recipient may create a group of phone numbers, calls from which the call recipient wants to receive at any time (e.g., a high priority group). Conversely, the call recipient may create a group which contains phone numbers, notification of calls from which is to be restricted to allow the system to act as a call blocking system. Another available option is to designate a group comprising a partial sequence of phone number digits. For example, a call recipient may specify merely three digits (e.g., an area code) as the required number to trigger the call handling function. That is, any call originating from the specified area code will trigger the ringer in the manner set forth for that group. Alternatively, a partial sequence of digits may be specified if a full incoming call number is not known to or remembered by the call recipient. For instance, the call recipient may recall only that a certain number includes the sequence “593.” Thus, the call recipient may specify that any number including the sequence “593” be handled according to the procedures for that group.

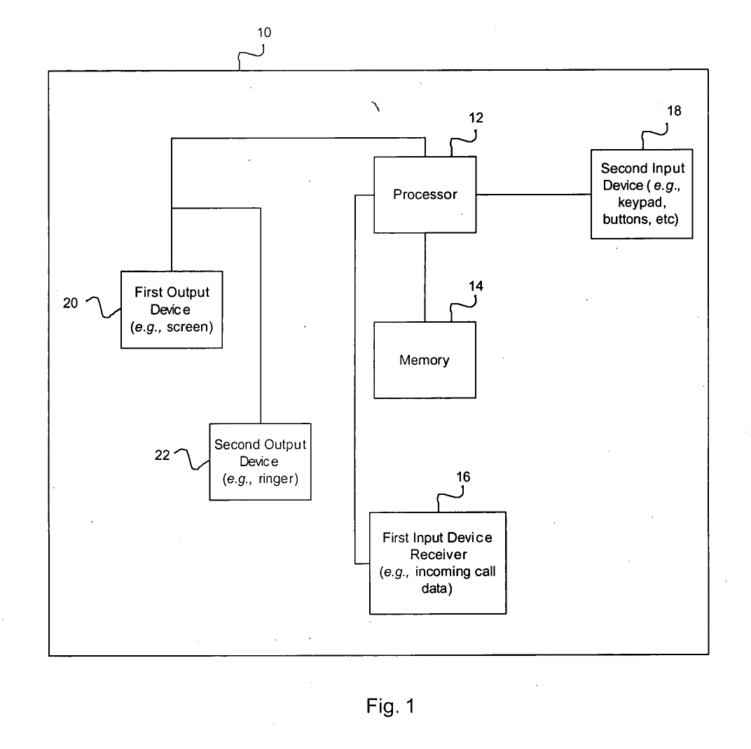

As shown in FIG. 1, a telephone system 10 which may employ a system according to the present invention may include a processor 12, a memory 14, first and second input devices 16 and 18, respectively, and first and second output devices 20 and 22, respectively. Those skilled in the art will understand that the components of the telephone system 10 may be incorporated in a single device or in any number of separate devices situated proximately or remotely. For example, clock and/or calendar data may be supplied to a plurality of cellular telephones from a central remote station, or one or more land line based phones may be connected to a central server which supplies any or all of the caller ID, calendar and/or clock functions, etc. The memory 14 may include operating code executed by the processor 12 to control operation of the telephone system 10 as well as data including, for example, a phone book, calendar data and user preference settings. The operating software may operate in conjunction with the software according to the present invention as described below. The first input device 16 may be a direct or cellular connection to a telephone or other network (e.g., the internet), while the second input device may be, for example, input keys or buttons on the telephone system 10. The telephone system 10 may further include first and second output devices 20 and 22, respectively, for providing data to the call recipient. The first output device 20 may, for example, be a data display screen while the second output device 22 may, for example, be a ringer. Those skilled in the art will understand that there may be a plurality of input and output devices incorporated within the telephone system 10.

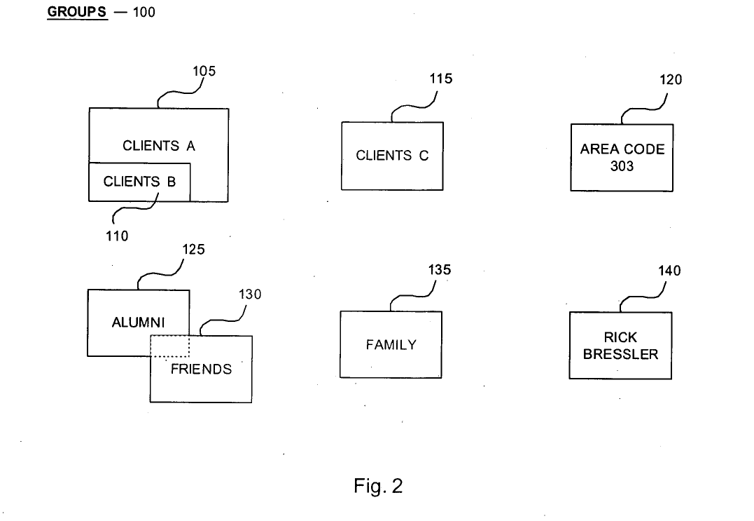

FIG. 2 shows an exemplary embodiment of a set of groups 105-140. Each of the groups 105-140 may contain one or more phone numbers, which may be stored in a memory of, for example, a cellular telephone. As will be understood by those of skill in the art, these numbers may be further identified by name or other data which, when displayed to the call recipient, identifies the caller or the source of the call. As noted above, the group may contain as few as one number (e.g., Rick Bressler group 140) or as many numbers as the call recipient desires. In addition to these group creation options, those skilled in the art will understand that there are a number of other grouping options which may be selected without departing from the scope of the invention. For example, selected numbers may be placed in more than one group. FIG. 1 shows an example of this type of overlap. Selected numbers that appear in Alumni group 125 also appear in Friends group 130. This recurrence is depicted by the overlie between the shapes representing the two separate groups. Another available function is an embedded grouping. In FIG. 1, Client B group 110 is embedded in Client A group 105. All the numbers included within Client B group 110 are also included in Client A group 105. This embedded arrangement allows the call recipient to specify a different set of notification options applicable only to the Client B group 110 at designated times while setting the same preferences to the entire Client A group 105, including the Client Group B 110 at other times.

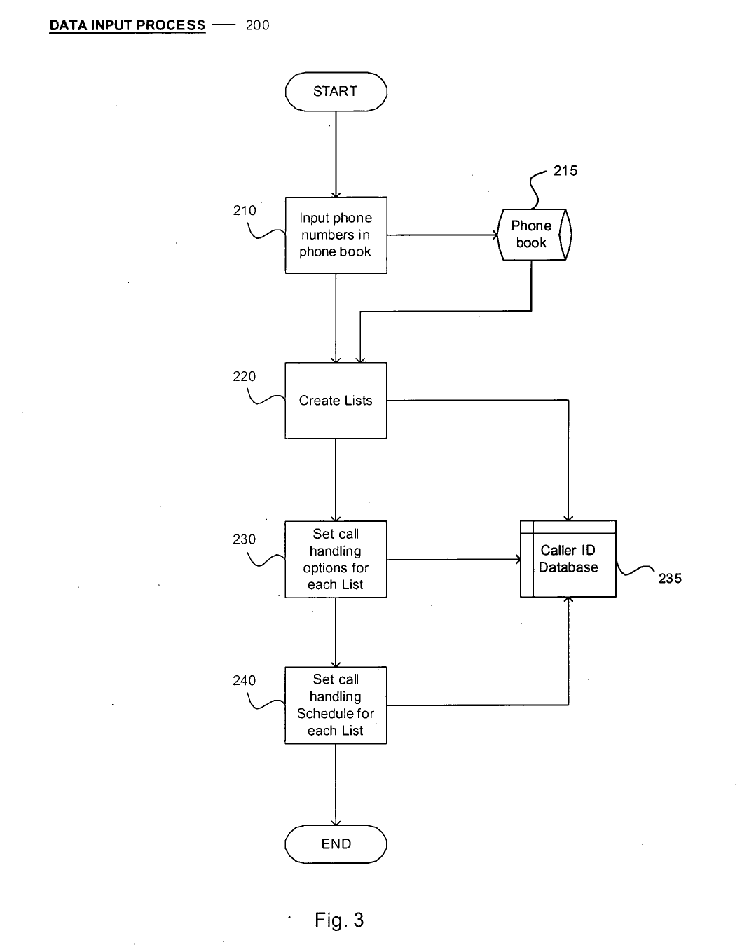

FIG. 3 illustrates an exemplary input process according to the present invention that a call recipient may follow in order to load desired incoming call numbers and settings into the memory 14 (e.g., call recipient preferences, etc.). Rather than having to individually set call processing options for each number stored in the memory 14, the ringer may be set to segregate the phone book entries into groups of numbers with each of the numbers in a given group being accorded similar treatment. That is, as a default, all numbers in a given group may be treated identically. However, a call recipient may be permitted to make modifications to the treatment of individual entries within the various groups. Furthermore, the inclusion of certain numbers in more than one group may result in different treatment for certain group entries with, for example, the highest priority group settings applicable, governing the handling of calls originating from a particular number. This simplifies the operations the call recipient must employ in order to personalize the system. In step 210 of the process, the call recipient inputs phone numbers into an internal database (e.g., phone book 215 in the memory 14). Those skilled in the art will recognize that such a database of phone numbers is not necessary. For example, a call recipient may alternatively, or in addition, create a group that contains only one or more area codes. In the next step 220, the call recipient creates groups from the phone book. Call processing options are then set for each of the groups in step 230 and stored in the caller ID database 235 along with the phone numbers associated with each of the groups. In the final step 240, the call recipient has the option of setting a schedule for each of the groups with the support of a clock and/or calendar. Of course, the call recipient may have the option of omitting any one of these steps and having the system set in a default mode without any customized preferences.

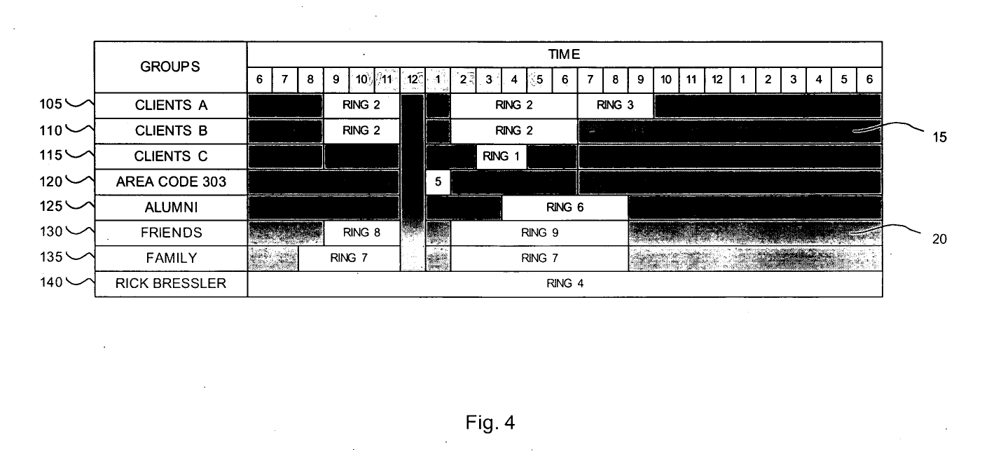

As indicated above in regard to step 240 of FIG. 3, this system also introduces a method by which to interrelate other available phone functions with caller ID to further customize the call processing options. An example of such an assimilation is the linking of such a call filtering function to a clock or calendar program. This allows a call recipient to pre-program settings that control call handling differently on certain days and/or at certain times. For example, a call recipient may indicate that in the early and later hours of the day, incoming calls from groups including work related numbers are not to activate the ringer, so that the processor 12 routes these directly to the voice mail system. These calls may optionally be entered in a call log after a silent ring notification. FIG. 4 shows an exemplary timetable for the handling of incoming calls from the various groups according to such a system. As indicated in FIG. 3, the call recipient has specified various call handling instructions for and has linked these instructions to the clock and/or calendar of the phone to alter call handling based on day and time (e.g., distinct audible rings, silent rings, straight to voice mail without any simultaneous notification, etc.). Each of the different shadings illustrated in FIG. 4 depicts a set of call handling instructions. Shading 15 represents a set of instructions directing calls directly to voice mail without activating the ringer. Shading 20 represents instructions to log calls in a record without activating the ringer, while rings 1-9 represent different tones or sets of tones from the ringer.

As indicated, call recipients may specify different sets of call handling instructions to be applied to calls originating from a particular group at different times of the day or at the same times on different days. Specifically, as shown in FIG. 4, the call recipient has indicated that during the early hours of 6 AM to 9 AM, incoming calls from numbers included in Clients A group 105 are to be forwarded directly to the voice mail system. The call recipient has pre-set the call handling instructions for Clients A group 105 so that, once work hours have begun, the phone will ring with Ring 1 until 12 PM, when the call recipient takes off from work for lunch. During the lunch hour, the call recipient has pre-set the phone to direct all calls for groups 105-135 directly to voice mail. During the next hour, 1 PM to 2 PM, the call recipient may have scheduled a meeting during which ringing phones are not desired. The call recipient has set the call handling instructions so that, during this hour, all incoming calls, except those from groups 120 and 140 are logged in an internal call log while the ringer is set to a silent ring. For the rest of the workday, i.e., from 2 PM to 7 PM, the ringer option for Clients A group 105 is set to ring Ring 2. After 6 PM, the ringer for these calls changes from Ring 2 to Ring 3. The call recipient has chosen to receive calls originating from those numbers listed in group 105 after the work day is over only until 10 PM. After this time and until the start of the next work day, all calls originating from any of groups 105-135 are forwarded directly to the voice mail system. Calls from groups 125-135 are set not to ring between the hours of 9 PM and 8 AM while the calls from group 140 will ring through at any time. Those skilled in the art will understand that the above is simply one of an infinite number of possible schedules available through implementation of the present invention. Furthermore, those skilled in the art will understand the rest of the preferences set by the call recipient based on the depiction in FIG. 4.

In addition to the clock function depicted in the timetable in FIG. 4, the call recipient may also implement calendar functions by setting different hourly, daily or monthly schedules to repeat periodically (e.g., setting different daily schedules for each of the days of the week) or for the work week and the weekend. A call recipient may set the daily schedule shown for Client A group 105 in FIG. 4 to repeat every Monday through Friday, while setting a different schedule for each Saturday and Sunday. This operation allows a call recipient to eliminate repeating the programming procedures described above for each different day and assures that a call recipient will not need to remember to make the changes every weekend and/or Monday in order to achieve the desired functionality. Furthermore, the phone ringer may be instructed to shut off at a user-specified time every day and to turn itself back on at a certain hour. For example, a call recipient may instruct a business cellular phone's ringer to shut off every day at 7 PM and to turn back on at 8 AM, Monday through Friday.

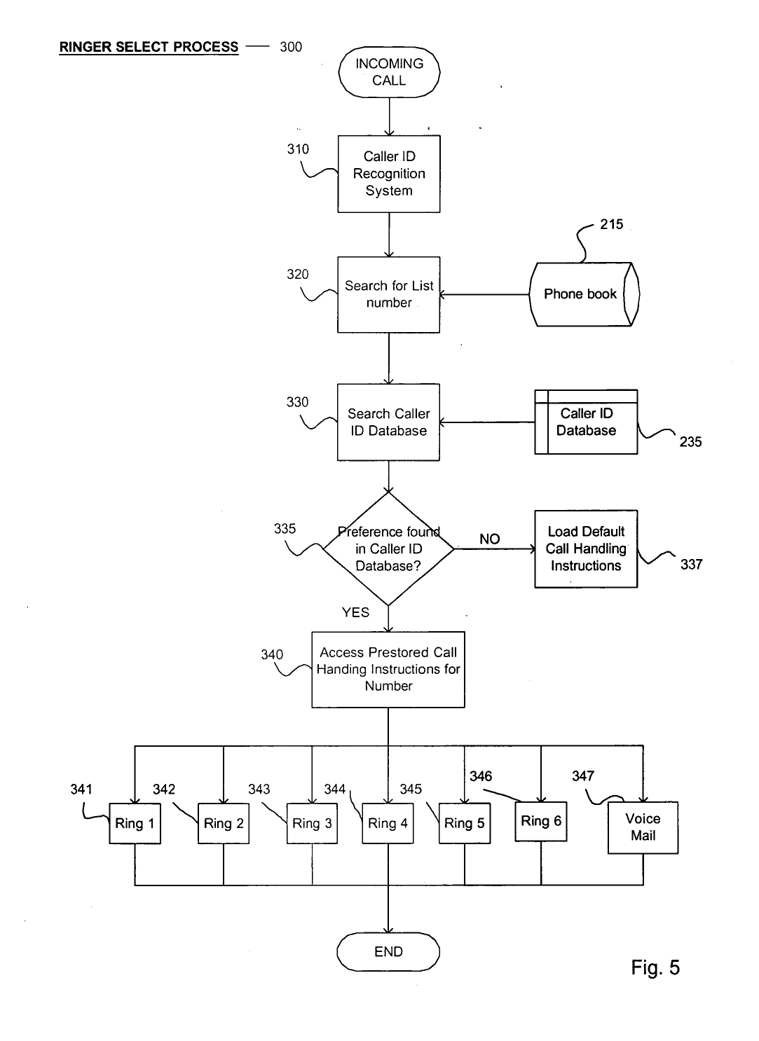

FIG. 5 illustrates an exemplary process implemented by the software when retrieving information for handling an incoming call. An operational sequence begins when a call arrives at the telephone system 10 and passes through a caller ID recognition system in step 310. During this step 310, the incoming call's information is immediately decoded by the caller ID system and then transmitted to the phone's input device (e.g., first input device 16). The system then searches the memory for the incoming phone number in step 320 and identifies a group to which the number is assigned, if any. For example, the telephone system 10 may search an internal database such as an internal phone book 215 shown in FIG. 5. Next, in step 330, a caller ID database 235, created by the call recipient (e.g., see FIG. 3), is searched for the incoming call data. In step 335, the search determines the call recipient's preset preferences for the incoming call or, if applicable, the default settings as indicated in step 337 and compares the time and date information from the clock and/or calendar to the call handling instructions corresponding to the call recipient's preset schedule to determine the appropriate actions. If the number is found, the system will implement the corresponding preset schedule actions in step 340.

As an alternate embodiment, or in conjunction with the above-described system, the telephone operating software according to the present invention may include a code activated call handling system. Under this system, certain callers may be assigned a security code, which when supplied to the telephone system 10, will instruct the telephone system 10 to handle the call in a pre-determined way despite instructions pertaining to a particular set of call handling instructions which would otherwise apply to the call. Such a code may be entered in any of a variety of ways depending on the mechanism being used. For example, on a telephone, the code may be a multi-digit touch-tone code or a voice password forwarded to a voice recognition mechanism, as is known in the art. In an exemplary application of this feature, the security code may give the caller a bypass to a blocked system and allow the telephone to ring instead of being transferred directly to voice mail.

This type of security code activation may also be applied to the voice mail system. Callers may be given a security code that activates the voice mail system or which alters the operation thereof For example, callers which do not have the security code may be prevented from leaving voice messages for the call recipient. Alternatively, a call recipient may define various voice mail “boxes” by different security codes so that, depending on which security code is entered, the operation of the voice mail system will be altered. For example, a call recipient may distinguish between personal and business-related voice mails by supplying different security codes to business and personal callers. Then, depending on the security code entered by a caller, the voice mail may be deposited, for example, in a corresponding voice mail box. In this way, a call recipient may decide which category of messages to access by selecting the appropriate voice mail box.

As described above, if the call recipient does not want to employ such a security code activation system, the present invention may allow the voice mail to be controlled based on the caller ID data for the incoming call. For instance, all calls from numbers not included in any of the defined groups may be prevented from leaving voice messages for the call recipient. Alternatively, messages may be sorted into different mail boxes based on the group in which the incoming call is stored. In this case a separate voice mail box may be defined for calls from numbers not included in any of the groups.

Integration of the above security code activation system may further tailor the phone's functions to the call recipient's needs. An example of this would be a system for handling a situation where a caller included in one of the groups is calling from a different phone. This caller may be given a security code that would allow him/her to obtain the same call handling features that he/she would have obtained in calling from the number included in a stored group. For instance, if caller A, who normally calls from a business phone included in group X, calls from a public telephone whose number is not included in the database, the call recipient's phone system may prompt caller A to enter a user-specified security code. Upon receipt of the security code, the call recipient's telephone may handle the call in the same manner that calls from the business phone number would be handled based on the stored preferences.

In a further embodiment of the invention, a telephone system 10 may be provided with a blinded caller ID feature. The present invention provides added security features to prevent confidential caller ID data from becoming known by unauthorized parties. A first option for such a feature is provided by a software system which allows the call recipient to program the caller ID display so that certain predetermined phone numbers will not be displayed. Thus, when a call is received from one of these pre-stored numbers, the caller ID display screen may remain blank or may continue to display the same list of calls that had been displayed previous to this call. Alternatively, the call recipient may set a security code caller ID feature such that no caller ID log will be displayed until a security code has been entered to activate the function. As described above, the security code may consist of a sequence of numbers that the call recipient may enter on a telephone keypad. Alternatively, as described above, the security code function may be voice-activated. Additionally, the call recipient may limit the activation of the security feature to a set of pre-selected numbers. The call recipient may also assign corresponding aliases to certain numbers so that only the call recipient will understand the true meaning of the displayed data for these calls. For example, a certain sensitive client may be directed to appear in the caller ID log as under a different name and number. The least complicated application of this set up to direct the caller ID log to display “unavailable” for all numbers within a defined group.

The above security measures may be applied similarly and equally to the voice mail system. Foe example, the call recipient may program a selective separation of voice mail so that a separate voice mail security code would need to be entered to access voice mail messages originating from numbers included in a pre-selected group. Furthermore, the call recipient may have one security code for high security messages and a separate security code for all other messages.

The present invention creates a telephone system 10 in which caller ID service is integrated with various other system features to allow a call recipient to customize the call receiving process. Those skilled in the art will recognize that any and all of the above functions and options may be incorporated with one another and implemented simultaneously if desired. With the different options and functions introduced in this invention, the call recipient will create a call filtering system that is narrowly tailored to the call recipient's needs.

In the preceding specification, the present invention has been described with reference to specific exemplary embodiments thereof. It will, however, be evident that various modifications and changes may be made there unto without departing from the broadest spirit and scope of the invention as set forth in the appended claims. The specification and drawings are, therefore, to be regarded in an illustrative rather thin restrictive sense.

1. A software package comprising:
a source identifying module for determining source data corresponding to a source of incoming telephone calls;
a call handling module including instructions for each of a plurality of call handling modes;
a handling mode selection module determining which call handling mode controls handling of an incoming call based on the source data and a time of receipt of the incoming call.

2. The software package according to claim 1, further comprising a call recipient preferences module storing call recipient input indicating a call handling mode to be applied to incoming calls based on the source data.

3. The software package according to claim 2, wherein the source data indicates a telephone number from which a corresponding incoming call originated and wherein the call recipient preferences module stores at least one telephone number along with a corresponding schedule indicating the call handling mode to be applied to incoming calls originating from the at least one telephone number based on one of a time and a day when a corresponding incoming call is received.

4. The software package according to claim 1, wherein the call handling modes include a first call handling mode in which the telephone provides an audible indication of incoming calls and a second call handling mode in which the telephone provides an inaudible indication of incoming calls.

5. The software package according to claim 4, wherein the first call handling mode includes a plurality of sub call handling modes with each of the sub call handling modes providing a corresponding audibly distinct indication of incoming calls.

6. The software package according to claim 1, wherein a first one of the call handling modes includes a first sub call handling mode which operates when a call recipient is currently engaged in a call wherein, when operating under the first sub call handling mode, the telephone provides to a call recipient an indication of a second incoming call.

7. The software package according to claim 4, wherein the call handling modes further include a third call handling mode in which incoming calls are transferred directly to a voice mail system without providing notification of the incoming call to the user.

8. The software package according to claim 1, further comprising a code detection mode for detecting input by a caller of a predetermined code, wherein, when the predetermined code is detected by the code detection module, the handling mode selection module is directed to select a call handling mode based on the detected code.

9. The software package according to claim 3, wherein the call recipient preferences module stores a plurality of telephone numbers organized into a plurality of groups along with a corresponding schedule for each of the groups, the schedules indicating the call handling modes to be applied to incoming calls from each of the groups depending on the time of receipt of the incoming calls.

10. The software package according to claim 9, wherein the call recipient preferences module indicates the predefined call handling mode to be applied to any incoming call including a predetermined sequence of digits.

11. A method of controlling operation of a telephone comprising the steps of:
extracting from an incoming call source data corresponding to a source of the call;
specifying a set of call handling instructions for each of a plurality of call handling modes;
selecting one of the call handling modes for each incoming call received based on the source data and a time of receipt of the incoming call.

12. The method according to claim 11, further comprising the step of storing call recipient input indicating a call handling mode to be applied to incoming calls based on the source data.

13. The method according to claim 12, wherein the step of storing call recipient input indicating a call handling mode to be applied to incoming calls based on the source data further includes the sub-step of storing call recipient input indicating a time schedule changing the call handling mode to be applied to incoming calls based on the time of receipt of the incoming calls.

14. The method according to claim 13, wherein the call recipient input indicating a time schedule controlling the call handling mode to be applied to incoming calls based on the time of receipt of the incoming call includes data corresponding to a day of receipt of the incoming calls.

15. The method according to claim 12, wherein the source data indicates a number from which a corresponding incoming call originated and wherein the call recipient input includes a sequence of numbers along with a corresponding schedule indicating the call handling mode to be applied to incoming calls including the sequence of numbers based on one of a time and a day when a corresponding incoming call is received.

16. The method according to claim 11, wherein the plurality of call handling modes includes a first call handling mode in which the telephone provides an audible indication of incoming calls and a second call handling mode in which the telephone provides an inaudible indication of incoming calls.

17. The method according to claim 16, wherein the first call handling mode includes a plurality of sub call handling modes with each of the sub call handling modes providing a corresponding audibly distinct indication of incoming calls.

18. The method according to claim 11, wherein a first one of the call handling modes includes a plurality of sub call handling modes, with a first sub call handling mode operating only when an incoming call is received while a call recipient is currently engaged in a call and a second sub call handling mode that operates only when an incoming call is received while a call recipient is not engaged in a call.

19. The method according to claim 16, wherein the call handling modes further include a third call handling mode in which incoming calls are transferred directly to a voice mail system without notification to a user.

20. The method according to claim 16, further comprising the steps of comparing input from a caller to a predetermined code and controlling selection of the call handling mode based on the comparison.

21. The method according to claim 15, wherein the call recipient input includes a plurality of sequences of numbers organized into a plurality of groups along with a corresponding schedule for each of the groups, the schedules indicating the call handling modes to be applied to incoming calls from each of the groups depending on the time of receipt of the incoming calls.

22. The method according to claim 11, wherein the call handling mode is selected based on a comparison of a predetermined sequence of digits to the source data, wherein the predetermined sequence of digits represents a part of a telephone number.

23. A telephone system comprising:
a source notification device, providing an indication to a call recipient of a source of each of a plurality of incoming calls;
a memory including operating code for controlling operation of the system, the operating code including a plurality of call handling modes which may be applied to incoming calls, and storing call recipient input indicating a corresponding one of the plurality of call handling modes to be applied to an incoming call based on the source data and a time of receipt of the incoming call.

24. The telephone system according to claim 23, further comprising a voice mail system, wherein under a first one of the plurality of call handling modes, corresponding incoming calls are forwarded directly to the voice mail system.

25. The telephone system according to claim 23, further comprising a call waiting system which handles incoming calls received while a call recipient is engaged on a call, wherein, the call handling modes control operation of the call waiting system based on the source data and the time of receipt of the incoming call.

26. The telephone system according to claim 23, wherein the source data indicates a telephone number from which a corresponding incoming call originated and wherein the call recipient input includes at least one telephone number along with a corresponding schedule indicating the call handling mode to be applied to incoming calls received from the at least one telephone number based on one of a time and a day of receipt of the incoming calls.

27. The telephone system according to claim 23, wherein a first call handling mode includes a plurality of sub call handling modes with each of the sub call handling modes providing a corresponding audibly distinct indication of incoming calls.

28. The telephone system according to claim 27, wherein, when a call recipient is currently engaged in a call and an incoming call is received, the sub call handling modes provide an audibly distinct indication of the incoming call based on the source data and the time of receipt of the incoming call.

29. The telephone system according to claim 27, wherein the call handling modes further include a third call handling mode in which corresponding calls are transferred directly to a voice mail system without notification to the user.

30. The telephone system according to claim 23, wherein the call recipient input includes a plurality of telephone numbers organized into a plurality of groups along with a corresponding schedule for each of the groups, the schedules indicating the call handling modes to be applied to incoming calls from each of the groups depending on the time of receipt of the incoming calls.
